(19) United States
(12) Patent Application Publication
(10) Pub. No.: US 2025/0362443 A1
(43) Pub. Date: Nov. 27, 2025

(54) POLARIZING PLATE AND OPTICAL DISPLAY APPARATUS

(71) Applicant: SAMSUNG SDI CO., LTD., Yongin-si (KR)

(72) Inventors: Jung Hun YOU, Suwon-si (KR); Bong Choon KIM, Suwon-si (KR); Su Yeon LEE, Suwon-si (KR); Gyeong Seo MIN, Suwon-si (KR); Soo Hyun LEE, Suwon-si (KR); Yong Un JUNG, Suwon-si (KR)

(21) Appl. No.: 19/217,759

(22) Filed: May 23, 2025

(30) Foreign Application Priority Data
May 23, 2024 (KR) 10-2024-0066998

(51) Int. Cl. G02B 5/30

(52) U.S. Cl. CPC G02B 5/3025; G02B 5/3083

(57) ABSTRACT

A polarizing plate and an optical display apparatus are provided. The polarizing plate includes a polarizer; and a retardation layer including a laminate of a positive C layer and a negative B layer and stacked on one surface of the polarizer, wherein the negative B layer has a degree of biaxiality of 1.5 or more at a wavelength of 550 nm, and the negative B layer has a Raman spectrum value of 10.20 or more as defined by Equation 1 in the disclosure.

### CROSS-REFERENCE TO RELATED APPLICATION

The present application claims priority to and the benefit of Korean Patent Application No. 10-2024-0066998, filed on May 23, 2024, in the Korean Intellectual Property Office, the entire disclosure of which is incorporated herein by reference.

### BACKGROUND

### 1. Field

One or more embodiments of the present invention relate to a polarizing plate and an optical display apparatus.

### 2. Description of the Related Art

A liquid crystal display includes a liquid crystal panel and polarizing plates arranged on both surfaces of the liquid crystal panel. As a liquid crystal operation mode for the liquid crystal display, an in-plane switching mode may be used.

The in-plane switching mode has an advantage of widening the viewing angle of the liquid crystal display. In recent years, as image displays including large-scale TVs and vehicular displays adopting the in-plane switching mode have been exploited and manufactured, wider viewing angle is desired and required. Therefore, there is a need for development of a polarizing plate securing good viewing angle. In addition, the polarizing plate is required to secure economic feasibility and processability by allowing production through a roll-to-roll process.

### SUMMARY

One or more aspects of embodiments of the present disclosure are directed toward a polarizing plate that provides an effect of improving lateral viewing angle and color visibility.

One or more aspects of embodiments of the present disclosure are directed toward a polarizing plate that provides an effect of suppressing light leakage.

One or more aspects of embodiments of the present disclosure are directed toward a polarizing plate free from delamination of a skin layer from a retardation layer.

One or more aspects of embodiments of the present disclosure are directed toward a polarizing plate that allows wide width manufacturing of a retardation layer, thereby improving manufacturing processability.

Additional aspects will be set forth in part in the description which follows and, in part, will be apparent from the description, or may be learned by practice of the presented embodiments of the disclosure.

According to one or more embodiments of the present disclosure, there is provided a polarizing plate.

The polarizing plate includes: a polarizer; and a retardation layer on (e.g., formed on) a (e.g., one) surface of the polarizer and including a positive C layer and a negative B layer, wherein the negative B layer has a degree of biaxiality of 1.5 or more at a wavelength of 550 nm and a Raman spectrum value of 10.20 or more, as defined according to Equation 1 provided herein.

The polarizing plate includes: a polarizer; and a retardation layer formed on one surface of the polarizer and including a positive C layer and a negative B layer, wherein the negative B layer has a degree of biaxiality of 1.5 or more at a wavelength of 550 nm and a Fourier transform infrared (FT-IR) spectrum value of 1.20 or more, as defined according to Equation 2 provided.

According to one or more embodiments of the present disclosure, there is provided an optical display apparatus. The optical display apparatus includes the polarizing plate set forth above.

According to one or more embodiments of the present disclosure, there is provided a polarizing plate free from delamination of a skin layer from a retardation layer.

According to one or more embodiments of the present disclosure, there is provides a polarizing plate that allows wide width manufacturing of a retardation layer, thereby improving manufacturing processability.

### BRIEF DESCRIPTION OF DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and benefits of the present disclosure will become more apparent to those of ordinary skill in the art from the following exemplary embodiments thereof described in detail with reference to the accompanying drawings.

FIG. 1 is a diagram of a film surface (skin layer) delaminating from a retardation layer.

FIG. 2 is a graph depicting evaluation results of a stretching ratio (Y-axis: fold) of a negative B layer and Raman spectrum intensity (Y-axis: arbitrary unit) depending on wavenumbers (X-axis: cm⁻¹) of Raman spectra according to one or more embodiments of the present disclosure.

FIG. 3 is a graph depicting evaluation results of absorbance (Y-axis: unitless) depending on wavenumbers (X-axis: cm⁻¹) of FT-IR spectra according to one or more embodiments of the present disclosure.

FIG. 4 is a cross-sectional view of a polarizing plate according to one or more embodiments of the present disclosure.

FIG. 5 is a cross-sectional view of a liquid crystal display according to one or more embodiments of the present disclosure.

FIG. 6 shows Raman spectra of a negative B layer according to one or more embodiments of the present disclosure and an enlarged view of a portion thereof, in which the X-axis indicates the wavenumber (cm⁻¹), the Y-axis indicates the intensity (Count) of the Raman spectra, a solid line indicates machine direction (MD) results of the negative B layer, and a dashed line indicates transverse direction (TD) results of the negative B layer.

FIG. 7 shows an FT-IR spectrum of the negative B layer according to one or more embodiments of the present disclosure, in which the X-axis indicates the wavenumber (cm⁻¹), the Y-axis indicates absorbance, a solid line indicates MD results of the negative B layer, and a dashed line indicates TD results of the negative B layer.

FIG. 8 is a picture showing an evaluation result of skin layer delamination of Example 1 of the present disclosure.

FIG. 9 is a picture showing an evaluation result of skin layer delamination of Comparative Example 1 of the present disclosure.

### DETAILED DESCRIPTION

Hereinafter, example embodiments of the present disclosure will be described in detail with reference to the accompanying drawings such that the present disclosure may be easily implemented by a person having ordinary knowledge in the art. It should be understood that the present disclosure may be embodied in different ways and is not limited to the following embodiments.

The terminology used herein is for the purpose of describing presented embodiments and is not intended to limit the present disclosure. As used herein, the singular forms “a”, “an”, and “the” are intended to include the plural forms as well, unless the context specifically indicates otherwise.

In the drawings, components unrelated to or nonessential to description are not provided for clear description of the disclosure, and like components will be denoted by like reference numerals throughout the disclosure. Because lengths, thicknesses or widths of various components may be exaggerated for understanding in the drawings, embodiments of the present disclosure are not limited thereto.

Herein, spatially relative terms, such as “upper” and “lower”, are defined with reference to the accompanying drawings. Thus, it will be understood that the term “upper surface” may be used interchangeably with the term “lower surface”. When an element such as a layer or film is referred to as being placed “on” another element, it may be directly placed on the other element, or one or more intervening element(s) may be present therebetween. In contrast, when an element is referred to as being placed “directly on” another element, there are no intervening element(s) therebetween.

Herein, “in-plane retardation Re”, “out-of-plane retardation Rth”, and “degree of biaxiality NZ” are represented by Equations A, B and C, respectively:

$$Re = ( nx - ny ) \times d , \qquad ( A )$$

$$Rth = ( ( nx - ny ) / 2 - nz ) \times d , \qquad ( B )$$

$$NZ = ( nx - nz ) / ( nx - ny ) , \qquad ( C )$$

where nx, ny, and nz are the indexes of refraction of a retardation layer, as measured in the slow axis direction, the fast axis direction, and the thickness direction thereof at a measurement wavelength, respectively, and d is the thickness thereof (unit: nm).

Herein, nx, ny, and nz refer to the indexes of refraction of a retardation layer in the slow axis direction, the fast axis direction, and the thickness direction thereof at a wavelength of 550 nm, respectively, unless clearly stated otherwise.

Herein, an axis in which the index of refraction in the in-plane direction attains a maximum level will be defined as the slow axis and an axis in which the index of refraction in the in-plane direction attains a minimum level will be defined as the fast axis. The slow axis may be substantially orthogonal to the fast axis, without being limited thereto.

According to one or more embodiments, a polarizing plate capable of improving lateral viewing angle and color visibility is provided. As a result, the polarizing plate may provide good black visibility.

According to one or more embodiments, a polarizing plate having an effect of suppressing light leakage through reduction in maximum light transmittance in all directions is provided. For example, in one or more embodiments, the polarizing plate may have a maximum light transmittance of about 0.5% or less, for example, 0% to about 0.5%, in all directions and may exhibit beneficial effects in suppression of light leakage within this range. Here, “light transmittance” refers to a degree of light leakage depending on viewing angle, assuming that backlight light is 100% when a display shows black, and is a value reflecting the tri-stimulus of the eye. A lower light transmittance indicates better viewing angle.

According to one or more embodiments, the polarizing plate allows wide width manufacturing of a retardation layer, thereby achieving improvement in manufacturing processability.

In one or more embodiments, the retardation layer may be free from delamination of a skin layer. If (e.g., when) the skin layer is delaminated, adhesion between the retardation layer and an adherend may be reduced, causing poor reliability of the polarizing plate and insufficient phase retardation of the retardation layer.

Next, delamination of the skin layer will be described.

An unstretched film produced by melt extrusion may have a difference in bonding cohesion between a film core and a film surface (skin layer). When the unstretched film is stretched in an MD (machine direction) or a TD (transverse direction), uneven shear stress may be generated in the film and reduce bonding strength between the film surface and the film core, causing the film surface to delaminate from the film core.

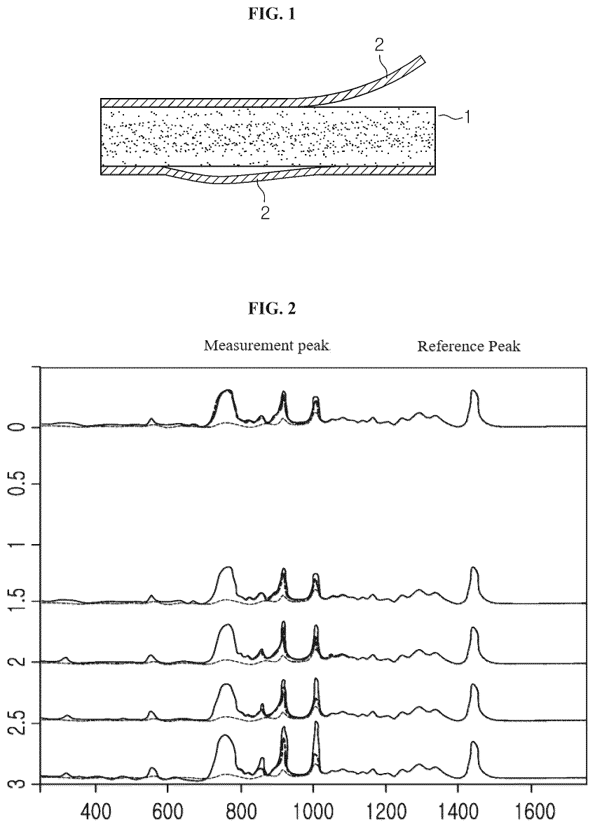

FIG. 1 is a diagram of a film surface (film skin layer) 2 delaminating from a film core 1 of a retardation layer.

According to one or more embodiments, the polarizing plate may include: a polarizer; and a retardation layer on (e.g., formed on) a (e.g., one) surface of the polarizer and including a positive C layer and a negative B layer, wherein the negative B layer has a degree of biaxiality of 1.5 or more at a wavelength of 550 nm and a Raman spectrum value of 10.20 or more, as defined according to Equation 1 below.

According to one or more embodiments, the polarizing plate may include: a polarizer; and a retardation layer on (e.g., formed on) a (e.g., one) surface of the polarizer and including a positive C layer and a negative B layer, wherein the negative B layer has a degree of biaxiality of 1.5 or more at a wavelength of 550 nm and an FT-IR spectrum value of 1.20 or more, as defined according to Formula 2 below.

In one or more embodiments, the negative B layer may be arranged between the polarizer and the positive C layer. With this structure, the negative B layer may secure good improvement in lateral viewing angle, color visibility, and light leakage.

A laminate of the positive C layer and the negative B layer may be arranged on a viewer-side polarizing plate or on a light source-side polarizing plate. It is desirable that the laminate be arranged such that a light absorption axis of the polarizer in the polarizing plate is orthogonal to an alignment direction of liquid crystal in an in-plane switching liquid crystal panel. The in-plane switching liquid crystal panel may be an IPS (in-plane switching) liquid crystal panel or an FFS (fringe field switching) liquid crystal panel.

In one or more embodiments, when the alignment direction of liquid crystals in an IPS panel, that is, a rubbing direction, is 90° with no voltage applied to the IPS panel, the absorption axis of the polarizer in the viewer-side polarizing plate is 0°, and the absorption axis of the polarizer in the light source-side polarizing plate is 90°, the laminate of the positive C layer and the negative B layer is arranged on the viewer-side polarizing plate such that the viewer-side polarizer, the negative B layer, the positive C layer, the in-plane switching liquid crystal panel, and the light source-side polarizer are sequentially stacked from the viewer-side polarizing plate. This structure is referred to as an O-mode structure in the art. In this structure, the positive C layer and the negative B layer may be stacked on a light incidence surface of the viewer-side polarizing plate.

In one or more embodiments, when the alignment direction of the liquid crystals in an IPS panel, that is, the rubbing direction, is 0° with no voltage applied to the IPS panel, the absorption axis of the polarizer in the viewer-side polarizing plate is 0°, and the absorption axis of the polarizer in the light source-side polarizing plate is 90°, the laminate of the positive C layer and the negative B layer is disposed on the light source-side polarizing plate such that the light source-side polarizer, the negative B layer, the positive C layer, the in-plane switching liquid crystal panel, and the viewer-side polarizer are sequentially stacked from the light source-side polarizing plate. This structure is referred to as an E-mode structure in the art. In this structure, the positive C layer and the negative B layer may be stacked on a light exit surface of the light source-side polarizing plate.

In the above embodiments, the laminate of the positive C layer and the negative B layer cannot be placed on the viewer-side polarizing plate and the light source-side polarizing plate at the same time.

Next, each component of the polarizing plate will be described in detail.

### Negative B Layer

The negative B layer is a retardation layer that satisfies a refractive index relation: nx>ny>nz (where nx, ny, and nz are the indexes of refraction of the negative B layer in the slow axis direction, the fast axis direction, and the thickness direction at a wavelength of 550 nm, respectively).

In one or more embodiments, the negative B layer may be a stretched film, as described below. The negative B layer has a slow axis and a fast axis in the in-plane direction. Assuming that the light absorption axis of the polarizer is 0°, the slow axis of the negative B layer may be tilted at an angle of −1° to 1° with respect to the light absorption axis of the polarizer. Within this range, the negative B layer may easily achieve improvement in lateral viewing angle, color visibility, and light leakage. For example, assuming that the light absorption axis of the polarizer is 0°, in one or more embodiments, the slow axis of the negative B layer may be tilted at an angle of about −0.5° to about 0.5°, or about 0°.

According to one or more embodiments, the slow axis of the negative B layer may be substantially orthogonal to the machine direction of the negative B layer and the fast axis of the negative B layer may be substantially parallel to the machine direction of the negative B layer. This structure facilitates production of the polarizing plate through a roll-to-roll process.

The negative B layer satisfies (i) a biaxiality degree of 1.5 or more at a wavelength of 550 nm and/or (ii) at least one of a Raman spectrum value of 10.20 or more, as defined by Equation 1 below or an FT-IR spectrum value of 1.20 or more, as defined by Equation 2 below.

The degree of biaxiality of the negative B layer may be set not only to achieve improvement in lateral viewing angle, color visibility, and light leakage of the polarizing plate, but also in consideration of the characteristics of the negative B layer that prevents delamination of the skin layer from the retardation layer described above.

In one or more embodiments, the negative B layer has a Raman spectrum value of 10.20 or more as defined by Equation 1:

$$Raman spectrum value = A / B , \qquad ( 1 )$$

where A is a value calculated by Equation 1-1:

$$A = \vert ( @ 921 {cm}^{- 1} / MD ) / \vert ( @ 1445 {cm}^{- 1} / MD ) , \qquad ( 1 - 1 )$$

where I(@921 cm⁻¹/MD) is the intensity of a resulting Raman spectrum at a wavenumber of 921 cm⁻¹ in the MD of the negative B layer, and
I(@1445 cm⁻¹/MD) is the intensity of a resulting Raman spectrum at a wavenumber of 1,445 cm⁻¹ in the MD of the negative B layer; and
where B is a value calculated by Equation 1-2:

$$B = \vert ( @ 921 {cm}^{- 1} / TD ) / \vert ( @ 1445 {cm}^{- 1} / TD ) , \qquad ( 1 - 2 )$$

where I(@921 cm⁻¹/TD) is the intensity of a resulting Raman spectrum at a wavenumber of 921 cm⁻¹ in the TD of the negative B layer, and
I(@1445 cm⁻¹/TD) is the intensity of a resulting Raman spectrum at a wavenumber of 1,445 cm⁻¹ in the TD of the negative B layer.

Two peaks required for calculation of Equation 1 are reference peaks of the Raman spectra: a peak at a wavenumber of 1,445 cm⁻¹ (e.g., about 1,445 cm⁻¹), which is a peak not affected by orientation of the negative B layer; and a peak at wavenumber 921 cm⁻¹ (e.g., about 921 cm⁻¹), which is a peak affected by orientation of the negative B layer.

FIG. 2 is a graph depicting evaluation results of Raman spectrum intensity at stretching ratios (Y-axis) of the negative B layer depending on the wavenumbers (X-axis) of the Raman spectrum according to one or more embodiments of the present disclosure. FIG. 2 shows intensity evaluation results using a peak at a wavenumber of 921 cm⁻¹ as a measurement peak with reference to a peak at a wavenumber of 1,445 cm⁻¹. Referring to FIG. 2, it could be seen that, even when the stretching ratio of the negative B layer was changed, the peak intensity at a wavenumber of 1,445 cm⁻¹ was substantially the same, whereas the peak intensity at a wavenumber of 921 cm⁻¹ was changed.

The negative B layer has an FT-IR spectrum value of 1.20 or more as defined by Equation 2:

$$FT - IR spectrum value = C / D \qquad ( 2 )$$

where C is a value calculated by Equation 2-1:

$$C = \vert ( @ 2860 {cm}^{- 1} / MD ) / \vert ( @ 1445 {cm}^{- 1} / MD ) \qquad ( 2 - 1 )$$

where I(@2860 cm⁻¹/MD) is the intensity of a resulting FT-IR spectrum at a wavenumber of 2,860 cm⁻¹ in the MD of the negative B layer, and
I(@1445 cm⁻¹/MD) is the intensity of a resulting FT-IR spectrum at a wavenumber of 1,445 cm⁻¹ in the MD of the negative B layer; and
where D is a value calculated by Equation 2-2:

$$D = \vert ( @ 2860 {cm}^{- 1} / TD ) / \vert ( @ 1445 {cm}^{- 1} / TD ) \qquad ( 2 - 2 )$$

where I(@2860 cm⁻¹/TD) is the intensity of a resulting FT-IR spectrum at a wavenumber of 2,860 cm⁻¹ in the TD of the negative B layer, and
I(@1445 cm⁻¹/TD) is the intensity of a resulting FT-IR spectrum at a wavenumber of 1,445 cm⁻¹ in the TD of the negative B layer.

Two peaks required for calculation of Equation 2 are reference peaks in the FT-IR spectrum: a peak at a wavenumber of 1,445 cm⁻¹ (e.g., about 1,445 cm⁻¹), which is a peak not affected by orientation of the negative B layer; and a peak at a wavenumber of 2,860 cm⁻¹ (e.g., about 2,860 cm⁻¹), which is a peak affected by orientation of the negative B layer.

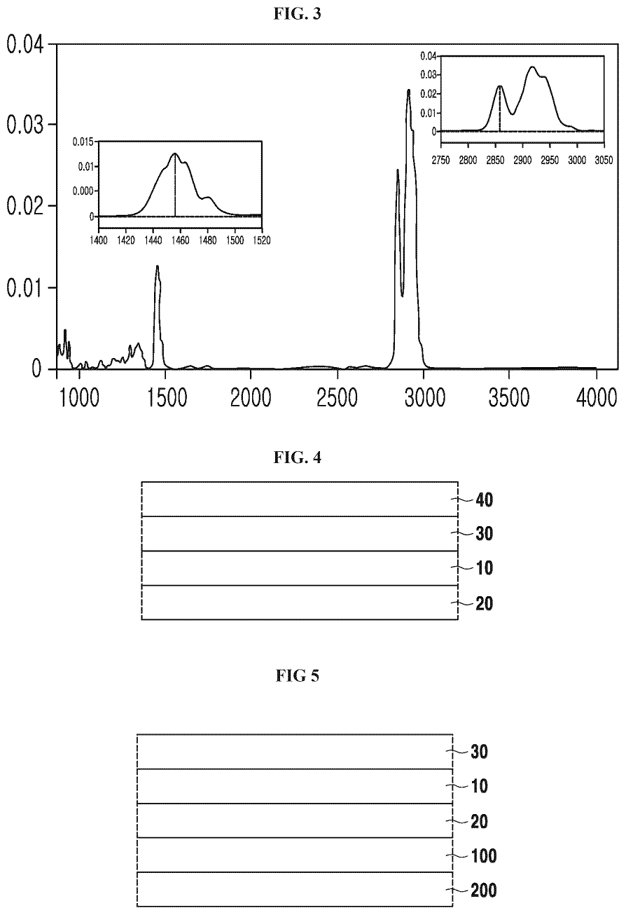

FIG. 3 is an evaluation result of intensity depending upon wavenumber of an FT-IR spectrum according to one or more embodiments of the present disclosure. Referring to FIG. 3, the intensities at a wavenumber of 2,860 cm⁻¹ and at a wavenumber of 1,445 cm⁻¹ were each obtained by defining a baseline as shown in an enlarged portion of FIG. 3, and subtracting an absorbance on the baseline from an absorbance at a wavenumber, at which the maximum absorbance appears.

The inventors of the present disclosure have completed the present invention by confirming that a negative B layer free from skin layer delamination among the negative B layers described above is formed by a manufacturing method described below, and that the negative B layer formed thereby has a value of 10.20 or more in Equation 1 and/or a value of 1.20 or more in Equation 2.

The negative B layer may be free from skin layer delamination when the value of Equation 1 is greater than or equal to 10.20 and/or the value of Equation 2 is greater than or equal to 1.2. For example, in one or more embodiments, the value of Equation 1 may be in a range of 10.20 to 20.0, for example, 10.20 to 13.0. For example, the value of Equation 2 may be in a range of 1.20 to 3.00, for example, 1.20 to 2.00.

Hereinafter, a method of manufacturing the negative B layer will be described.

The negative B layer may be formed of any material so long as the material may simultaneously satisfy the degree of biaxiality and the value of Equation 1 and/or the value of Equation 2.

In one or more embodiments, the negative B layer is prepared through melt extrusion of a composition including a resin having positive birefringence to prepare an unstretched film, followed by biaxially stretching the unstretched film at a TD stretching ratio of about 1.2 times or more an initial length thereof in the TD of the unstretched film. The positive birefringence means that the index of refraction of the corresponding material increases in the stretching direction thereof. In such embodiments, the degree of biaxiality of the negative B layer described above, the value of Equation 1, and the value of Equation 2 may be easily achieved.

Here, the TD stretching ratio TD means the ratio of a TD length of a final stretched film to a TD length of an unstretched film.

For example, in one or more embodiments, the unstretched film may be prepared by melt extruding a composition including the resin having positive birefringence. The positive birefringence means that the index of refraction of the material increases in the stretching direction. That is, the stretching direction coincides with the slow axis.

For example, the resin having positive birefringence may include a cyclic olefin polymer (COP) resin. The cyclic olefin polymer resin may facilitate implementation of the negative B layer according to the present disclosure.

Melt extrusion is a process of producing an unstretched film by heating a polymer to a molten state and then extruding the molten polymer through an extrusion apparatus. Accordingly, melt extrusion may secure good productivity with relatively low equipment costs. Melt extrusion may be carried out by melting the above resin alone or a composition including the above resin at a temperature higher than the melting point of the resin, followed by extruding the molten material.

According to one or more embodiments, the unstretched film may have a thickness of about 80 micrometers (μm) to about 10 μm, for example, about 50 μm to about 20 μm.

Uniaxial stretching in the TD refers to uniaxial stretching of the unstretched film in the TD of the unstretched film, in which the TD uniaxial stretching ratio may be about 1.2 times or more, for example, about 1.2 to about 2.0 times, for example, about 1.2 to about 1.40 times. Within this range, the value of Equation 1 and the value of Equation 2 may be easily achieved.

Although uniaxial stretching in the TD may be performed depending on the glass transition temperature of the unstretched film, it may be performed at a temperature of between about 135° C. and about 185° C., for example, between about 155° C. and about 175° C. Within this range, the value of Equation 1 and the value of Equation 2 may be easily achieved.

According to one or more embodiments, the negative B layer may have an in-plane retardation of about 70 nm to about 150 nm at a wavelength of 550 nm. Within the above ranges of the in-plane retardation and the degree of biaxiality, the negative B layer may easily achieve improvement in lateral viewing angle, color visibility, and light leakage when stacked on a (e.g., one) surface of the positive C layer described above. A polarizing plate including a negative B layer that satisfies neither the in-plane retardation nor the degree of biaxiality may exhibit insignificant improvement in lateral viewing angle and color visibility.

For example, in one or more embodiments, the negative B layer may have an in-plane retardation of about 70 nm to about 130 nm, for example, about 80 nm to about 120 nm.

According to one or more embodiments, the negative B layer may have an out-of-plane retardation of about 35 nm to about 195 nm at a wavelength of 550 nm. Within this range, the negative B layer may easily achieve the in-plane retardation and the degree of biaxiality within the above ranges. For example, in one or more embodiments, the negative B layer may have an out-of-plane retardation of about 35 nm to about 143 nm, for example, about 40 nm to about 120 nm, or about 48 nm to about 120 nm.

In one or more embodiments, the negative B layer may have a thickness of about 20 μm to about 80 μm, about 25 μm to about 75 μm, or about 30 μm to about 60 μm. Within this range, the negative B layer may be used in the polarizing plate.

### Positive C Layer

The positive C layer may have an out-of-plane retardation of about −150 nm to about −70 nm at a wavelength of 550 nm. Within this range, the positive C layer may easily achieve improvement in lateral viewing angle and light leakage when stacked on the negative B layer. For example, in one or more embodiments, the positive C layer may have an out-of-plane retardation of about −140 nm to about −80 nm, or about−135 nm to about −80 nm, at a wavelength of 550 nm.

The positive C layer may have an in-plane retardation of 0 nm to about 10 nm at a wavelength of 550 nm. Within this range, the positive C layer may easily achieve improvement in lateral viewing angle and light leakage when stacked on the negative B layer. For example, in one or more embodiments, the positive C layer may have an in-plane retardation of 0 nm to about 5 nm, or 0 nm to about 3 nm, at a wavelength of 550 nm.

The positive C layer may be formed of a material that satisfies a relation: nz>nx=ny at a wavelength of 550 nm (where nx, ny, and nz are the indexes of refraction in the slow axis direction, the fast axis direction, and the thickness direction at a wavelength of 550 nm, respectively) and can realize the in-plane retardation and the out-of-plane retardation within the above ranges.

In one or more embodiments, the positive C layer may be a stretched film. For example, the positive C layer may be a stretched film formed of a composition including at least one resin selected from among cellulose resins, polyester resins including polyethylene terephthalate, polybutylene terephthalate, polyethylene naphthalate, polybutylene naphthalate, and/or the like, cyclic olefin polymer (COP) resins, polycarbonate resins, polyether sulfone resins, polysulfone resins, polyamide resins, polyimide resins, polyolefin resins, polyarylate resins, polyvinyl alcohol resins, polyvinyl chloride resins, polyvinylidene chloride resins, acrylic resins, and polystyrene resins.

In one or more embodiments, the positive C layer may be a coating layer formed of a composition including at least one selected from among a cellulose compound or a polymer thereof, and/or an aromatic compound or a polymer thereof. In these embodiments, the positive C layer may be formed by coating the composition to a predetermined or set thickness on a (e.g., one) surface of the negative B layer and curing the composition without stretching (the positive C layer is a non-stretched layer). In one or more embodiments, the positive C layer may be directly formed on the negative B layer. As used herein, “directly formed” means that there is no adhesive or bonding layer between the positive C layer and the negative B layer. When the positive C layer is “directly formed” thereon, the entire thickness of the retardation layer may be reduced to achieve reduction in thickness of the polarizing plate.

In one or more embodiments, the positive C layer may be formed by coating a composition for the positive C layer to a predetermined or set thickness on a (e.g., one) surface of a base film, followed by curing. In these embodiments, the positive C layer may be transferred to the negative B layer to form a laminate of the negative B layer and the positive C layer. In the laminate, the positive C layer may be stacked on the negative B layer by an adhesive layer or a bonding layer without being limited thereto. Although the laminate according to the embodiments may provide the same optical properties as the laminate of the negative B layer and the positive C layer according to the above embodiments, the thickness of the laminate tends to slightly increase due to the adhesive layer or the bonding layer. However, this structure does not depart from the scope of the present invention.

The cellulose compound may include at least a unit in which at least some hydrogen atoms of hydroxyl groups [a C2 hydroxyl group, a C3 hydroxyl group, or a C6 hydroxyl group] of a sugar monomer/unit constituting cellulose are substituted with an acyl group or an ether group. That is, the cellulose compound may include at least one of a cellulose ester compound or a cellulose ether compound.

For example, the cellulose compound may include a cellulose ester polymer including at least a unit in which at least some hydrogen atoms of hydroxyl (OH) groups [a C2 hydroxyl group, a C3 hydroxyl group, or a C6 hydroxyl group] of a sugar monomer/unit constituting cellulose are substituted with an acyl group, as represented by Formula 1. Here, the acyl group may be substituted or unsubstituted.

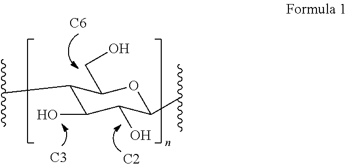

In Formula 1, n is an integer greater than or equal to 1.

Substituent groups for the cellulose ester compound or the acyl group may include at least one selected from among a halogen, a nitro group, an alkyl group (for example, a C₁ to C₂₀ alkyl group), an alkenyl group (for example, a C₂ to C₂₀ alkenyl group), a cycloalkyl group (for example, a C₃ to C₁₀ cycloalkyl group), an aryl group (for example, a C₆ to C₂₀ aryl group), a heteroaryl group (for example, a C₃ to C₁₀ aryl group), an alkoxy group (for example, a C₁ to C₂₀ alkoxy group), an acyl group, and a halogen-containing functional group. The substituent groups may be the same as or different from each other.

Herein, “acyl” may refer to R—C(═O)—* (* being a linking site, R being a C₁ to C₂₀ alkyl group, a C₃ to C₂₀ cycloalkyl group, a C₆ to C₂₀ aryl group, or a C₇ to C₂₀ arylalkyl group), as known in the art. The “acyl” is coupled to a ring of the cellulose through ester bonding (through an oxygen atom) in the cellulose.

Here, “alkyl”, “alkenyl”, “cycloalkyl”, “aryl”, “heteroaryl”, “alkoxy”, and “acyl” may refer to non-halogen groups free from halogen atoms for convenience. The composition for the positive C layer may include the cellulose ester compound alone or a mixture including the cellulose ester compound.

Here, “halogen” refers to fluorine (F), chlorine (CI), bromine (Br), or iodine (I), for example, F.

The “halogen-containing functional group” is an organic functional group containing at least one halogen atom and may include an aromatic, aliphatic, or alicyclic functional group. For example, the halogen-containing functional group may include a halogen-substituted C₁ to C₂₀ alkyl group, a halogen-substituted C₂ to C₂₀ alkenyl group, a halogen-substituted C₂ to C₂₀ alkynyl group, a halogen-substituted C₃ to C₁₀ cycloalkyl group, a halogen-substituted C₁ to C₂₀ alkoxy group, a halogen-substituted acyl group, a halogen-substituted C₆ to C₂₀ aryl group, or a halogen-substituted C₇ to C₂₀ arylalkyl group, without being limited thereto.

The “halogen-substituted acyl group” may be R′—C(═O)—* (* being a linking site, R′ being a halogen-substituted C₁ to C₂₀ alkyl group, a halogen-substituted C₃ to C₂₀ cycloalkyl group, a halogen-substituted C₆ to C₂₀ aryl group, or a halogen-substituted C₇ to C₂₀ arylalkyl group). The “halogen-substituted acyl group” may be coupled to a ring of the cellulose through ester bonding (through an oxygen atom) in the cellulose.

For formation of the positive C layer, the cellulose ester compound may be prepared by a general method known to those skilled in the art or may be obtained from commercially available products. For example, the cellulose ester compound having an acyl group as a substituent group may be prepared by reacting trifluoroacetic acid or trifluoroacetic anhydride with the sugar monomer/unit constituting the cellulose represented by Formula 1 or a polymer of the sugar monomer, by reacting trifluoroacetic acid or trifluoroacetic anhydride therewith, followed by additionally reacting an acylation agent (for example, an anhydride of carboxylic acid, or carboxylic acid) therewith, or by reacting both trifluoroacetic acid or trifluoroacetic anhydride and the acylation agent therewith.

The aromatic compound includes a phenyl group and may include a polystyrene compound or a fluorobenzene or difluorobenzene structure, without being limited thereto. In one or more embodiments, the polystyrene compound may include a moiety represented by Formula 2.

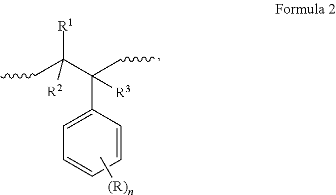

In Formula 1, [symbol] is a linking site of an element (e.g., a linking site to a neighboring moiety);
R¹, R², and R³ may each independently be hydrogen, an alkyl group, a substituted alkyl group, or a halogen;
R(s) may each independently be a substituent group on a styrene/phenyl ring; and
n may be an integer of 0 to 5 indicating the number of substituent groups on the styrene/phenyl ring.

Non-limiting examples of the substituent group R on the styrene/phenyl ring may include an alkyl group, a substituted alkyl group, a halogen, a hydroxyl group, a carboxyl group, a nitro group, an alkoxy group, an amino group, a sulfonate group, a phosphate group, an acyl group, an acyloxy group, a phenyl group, an alkoxycarbonyl group, a cyano group, and the like.

In one or more embodiments, at least one of R¹, R², or R³ may be a halogen, for example, fluorine.

The composition for the positive C layer may further include an aromatic fused ring-containing compound as an additive. The aromatic fused ring-containing compound serves to adjust wavelength dispersion of the positive C layer. The aromatic fused ring-containing compound may include 2-naphthyl benzoate, anthracene, phenanthrene, 2,6-naphthalene dicarboxylic acid diester, and the like. The aromatic fused ring-containing compound/additive may be optionally present in an amount of about 0.1 wt % to about 30 wt %, for example about 1 wt % to about 10 wt %, in the composition for the positive C layer, based on a total weight of 100 wt % of the composition. Within this range, the aromatic fused ring-containing compound/additive may adjust the retardation rate and wavelength dispersion of the polarizing plate.

The positive C layer may have a thickness of about 1 μm to about 60 μm, for example, about 1 μm to about 30 μm, or about 1 μm to about 10 μm. Within this range, the positive C layer may be applied to a polarizing plate, may easily realize phase retardation according to the present disclosure, and may reduce the thickness of the polarizing plate.

### Laminate of Positive C Layer and Negative B Layer

The laminate of the positive C layer and the negative B layer may have an in-plane retardation of about 70 nm to about 150 nm at a wavelength of 550 nm. Within this range, the polarizing plate may secure beneficial effects in improvement of lateral viewing angle and color visibility. For example, in one or more embodiments, the laminate may have an in-plane retardation of about 70 nm to about 130 nm, for example, about 80 nm to about 120 nm, at a wavelength of 550 nm.

The laminate of the positive C layer and the negative B layer may have an out-of-plane retardation of about −52 nm to about 30 nm at a wavelength of 550 nm. If (e.g., when) the out-of-plane retardation of the laminate is less than −52 nm, the polarizing plate may reduce black visibility, provide insignificant improvement in suppression of light leakage, and allow purple or yellow to be visible during color evaluation, thereby providing poor improvement in color visibility. If (e.g., when) the out-of-plane retardation of the laminate is greater than 30 nm, the polarizing plate may reduce black visibility, provide insignificant improvement in suppression of light leakage, and allow purple or yellow to be visible during color evaluation, thereby providing poor improvement in color visibility. For example, in one or more embodiments, the laminate may have an out-of-plane retardation of about −50 nm to about 20 nm, for example, about −40 nm to about 10 nm, about −30 nm to about 0 nm, about −30 nm to about −5 nm, or about −30 nm to about −10 nm, at a wavelength of 550 nm.

The thickness of the laminate may be about 95% or more, for example, about 95% to 100%, for example, 100%, of the thickness of the retardation layer. Within this range, the polarizing plate may achieve thickness reduction.

### Polarizer

The polarizer serves to convert incident natural light or polarized light into linearly polarized light in a certain direction and may be produced from a polymer film containing a polyvinyl alcohol resin as a main component thereof. For example, the polarizer may be produced by dyeing the polymer film with iodine or dichroic dyes, followed by stretching the dyed polymer film in the machine direction (MD). In one or more embodiments, the polarizer may be produced by subjecting a polyvinyl alcohol film to swelling, dyeing, stretching, and optionally at least one of color correction and crosslinking.

The polarizer has a light absorption axis and a light transmission axis in the in-plane direction thereof, in which the light absorption axis may be the MD of the polarizer, and the light transmission axis may be the TD (transverse direction) thereof.

The polarizer may have a total light transmittance of about 40% or more, for example, about 40% to about 46%, and a degree of polarization of about 95% or more, for example, about 95% to about 99.999%. Within these ranges, the polarizer may increase anti-reflection performance when combined with the retardation layer. Here, “light transmittance” and “degree of polarization” are measured at a wavelength of 380nm to 780 nm and reflect visibility in the corresponding wavelength range.

The polarizer may have a thickness of about 2 μm to about 30 μm, for example, about 4 μm to about 25 μm. Within this range, the polarizer may be used in the polarizing plate.

The polarizer may be directly stacked on the negative B layer without an adhesive layer or a bonding layer as described below, or may be stacked on the negative B layer via an adhesive layer or a bonding layer.

Within the above range and manner, it may realize reduction in thickness of the polarizing plate.

In one or more embodiments, the polarizing plate may further include a protective layer on one surface of the polarizer and/or on the other surface thereof.

### First Protective Layer

In one or more embodiments, the polarizing plate may further include at least one first protective layer on one surface of the polarizer, for example, on a surface including the retardation layer of the polarizer thereon. The first protective layer may be included in the laminate to provide additional functions to the laminate and/or the polarizing plate. For example, the first protective layer may complement the thickness of the laminate to increase durability and mechanical strength of the laminate.

The first protective layer is an optically transparent film and may be, for example, a film formed of at least one resin selected from among cellulose resins including triacetylcellulose (TAC) and the like, polyester resins including polyethylene terephthalate, polybutylene terephthalate, polyethylene naphthalate, polybutylene naphthalate, and the like, cyclic olefin polymer (COP) resins, cyclic olefin copolymer (COC) resins, polycarbonate resins, polyether sulfone resins, polysulfone resins, polyamide resins, polyimide resins, polyolefin resins, polyarylate resins, polyvinyl alcohol resins, polyvinyl chloride resins, and polyvinylidene chloride resins.

For example, in one or more embodiments, the first protective layer may be disposed between the polarizer and the positive C layer.

In one or more embodiments, the first protective layer may have a front in-plane retardation and an out-of-plane retardation of each about 10 nm or less, for example, 0 nm to about 5 nm, at a wavelength of 550 nm. Within this range, the first protective layer does not impair the effect of reducing reflectance at lateral sides by the laminate.

In one or more embodiments, the polarizing plate may further include a second protective layer described below on the other surface of the polarizer. At least one second protective layer may be stacked on an upper surface of the polarizer.

### Second Protective Layer

The second protective layer serves to protect the polarizer from an external environment while increasing mechanical strength of the polarizing plate. The second protective layer may be at least one of a protective film or a protective coating layer.

In one or more embodiments, the second protective layer is an optically transparent film and may be, for example, a film formed of at least one resin selected from among cellulose resins including triacetylcellulose (TAC) and the like, polyester resins including polyethylene terephthalate (PET), polybutylene terephthalate, polyethylene naphthalate, polybutylene naphthalate, and the like, cyclic olefin polymer (COP) resins, cyclic olefin copolymer (COC) resins, polycarbonate resins, polyether sulfone resins, polysulfone resins, polyamide resins, polyimide resins, polyolefin resins, polyarylate resins, polyvinyl alcohol resins, polyvinyl chloride resins, and polyvinylidene chloride resins.

In one or more embodiments, a functional coating layer may be further formed on at least one surface of the second protective layer. For example, the functional coating layer may be an anti-reflective layer, a low-reflectivity layer, a hard coating layer, an anti-fingerprint layer, an antiglare layer, a primer layer, or the like.

The second protective layer may have a thickness of about 5 μm to about 70 μm, for example, about 15 μm to about 45 μm. Within this range, the second protective layer may be used in the polarizing plate.

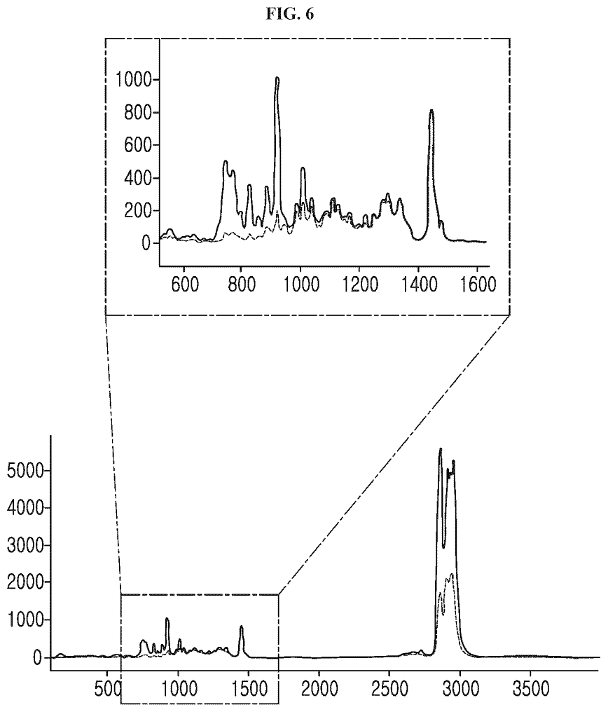

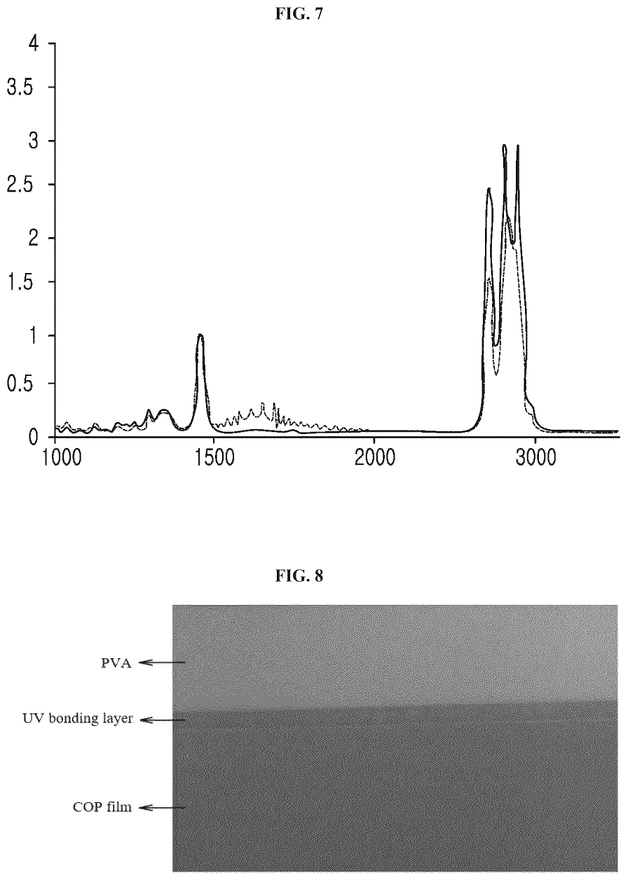

FIG. 4 is a cross-sectional view of a polarizing plate according to one or more embodiments of the present disclosure.

Referring to FIG. 4, a polarizing plate according to one embodiment may include a polarizer 30; a negative B layer 10 and a positive C layer 20 sequentially stacked on a lower surface of the polarizer 30; and a second protective layer 40 formed on an upper surface of the polarizer 30.

An optical display apparatus according to one or more embodiments of the present disclosure may include the polarizing plate according to the embodiments of the present disclosure. The optical display apparatus may include a liquid crystal display.

In one or more embodiments, the liquid crystal display may include a liquid crystal layer in an in-plane switching mode, and may be an IPS liquid crystal display, an FFS liquid crystal display, or the like.

In one or more embodiments, the polarizing plate may be used as a viewer-side polarizing plate or a light source-side polarizing plate.

FIG. 5 is a cross-sectional view of a liquid crystal display according to one or more embodiments of the present disclosure. Referring to FIG. 5, a liquid crystal display may include a liquid crystal panel 100 including a liquid crystal layer, a viewer-side polarizing plate stacked on one surface of the liquid crystal panel 100, and a light source-side polarizing plate 200 stacked on the other surface of the liquid crystal panel 100, in which the viewer-side polarizing plate includes a positive C layer 10, a negative B layer 20, and a polarizer 30 sequentially stacked from the liquid crystal panel 100.

Referring to FIG. 5, the liquid crystal layer may be a liquid crystal layer in an in-plane switching mode, for example, a liquid crystal layer in an IPS mode. The slow axis of the liquid crystal layer is substantially orthogonal to the light absorption axis of the polarizer of the viewer-side polarizing plate. The light absorption axis of the polarizer of the viewer-side polarizing plate is substantially orthogonal to the light absorption axis of the polarizer of the light source-side polarizing plate. In the liquid crystal layer, liquid crystals may be aligned at a liquid angle tilt angle of 0° to about 3°. The “liquid crystal tilt angle” may be measured by a general method known to those skilled in the art.

Next, the present disclosure will be described in more detail with reference to some examples. However, it should be noted that these examples are provided for illustration only and are not to be construed in any way as limiting the present invention.

### Example 1

A polarizer (total light transmittance: 43%) was manufactured by dyeing a polyvinyl alcohol film (PS #60, pre-stretching thickness: 60 μm, Kuraray Co., Ltd., Japan) in an aqueous solution of iodine at 55° C., followed by uniaxially stretching the polyvinyl alcohol film to 6 times an initial length thereof in the MD of the film.

An unstretched film was prepared through melt extraction of a composition containing a cyclic olefin polymer (COP) resin. A negative B layer having features shown in Table 1 was prepared through uniaxial stretching of the unstretched film to 1.3 times an initial length thereof in the TD of the unstretched film.

A laminate of a release PET film and a positive C layer (Rth: −110 nm at 550 nm, Re: 0 nm at 550 nm, thickness: 4.6 μm) was prepared by depositing a cellulose ester composition (VM500, Eastman, USA) to a predetermined or set thickness on one surface of a release film (polyethylene terephthalate film), followed by curing the composition (no stretching process).

A polyethylene terephthalate film was bonded to an upper surface of the polarizer through a bonding layer and the negative B layer was bonded to a lower surface of the polarizer through a bonding layer. Then, the laminate of the positive C layer and the release PET film was attached to a lower surface of the negative B layer through an adhesive layer and the release PET film was removed from the laminate, thereby preparing a polarizing plate including the polyethylene terephthalate film, the polarizer, the negative B layer, and the positive C layer.

### Examples 2 to 5

Polarizing plates were each prepared in substantially the same manner as in Example 1 except that the TD uniaxial stretching ratio, the conditions for melt extrusion, and/or the out-of-plane retardation of the positive C layer were changed in formation of the negative B layer.

### Comparative Examples 1 to 3

Polarizing plates were each prepared in the substantially same manner as in Example 1 except that the TD uniaxial stretching ratio, the conditions for melt extrusion, and/or the out-of-plane retardation of the positive C layer were changed in formation of the negative B layer.

(1) Re, Rth, and NZ of each of the retardation layers were measured at a wavelength of 550 nm using an AXOSCAN.

(2) The value of Equation 1 for the negative B layer was calculated in the following sequence.

Raman spectra were evaluated for the negative B layer. The Raman spectra were measured in a dispersive manner using laser beams with a wavelength of 514 nm. The Raman spectra were obtained under conditions of grating: 1,800 l/mm, power: 10%, exposure time: 10 sec, accumulation: 3 times or more, and measurement area/range: 100 cm⁻¹ to 4000 cm⁻¹. The Raman spectra were measured at a depth of 20 μm from a surface of the negative B layer. After measuring the Raman spectra, peak heights at wavenumbers of 921 cm⁻¹ and 1,445 cm⁻¹ were obtained to calculate the value of Equation 1. FIG. 6 shows results of Raman spectrum evaluation for the negative B layers of Examples.

(3) The value of Equation 2 for the negative B layer was measured in the following sequence.

Absorbance spectra for the negative B layer were evaluated by transmission and attenuated total reflectance (ATR) methods using a Fourier transform infrared spectrophotometer (Thermo Fisher, product name: iS50). In the case where transmission spectroscopy analysis resulted in a saturated absorbance signal, the absorbance spectra were evaluated by the ATR method using a grazing IR accessory (Harrick Seagull™ Variable Angle Reflection Accessory) and a Ge hemisphere. A linear polarizer was placed between the negative B layer and a detector to selectively measure signals coming from the negative B layer in the MD or the TD. An infrared incidence angle of the Grazing IR accessory was evaluated by adjusting the angle between 20° and 45°. Among the obtained spectra, peak heights at wavenumbers of 2,860 cm⁻¹ and 1,445 cm⁻¹ were obtained to calculate the value of Equation 2.

The following properties were evaluated on the polarizing plates of Examples and Comparative Examples and evaluation results are shown in Table 1.

(1) Omnidirectional maximum light transmittance: The polarizing plate prepared in each of Examples and Comparative Examples was attached as a viewer-side polarizing plate to a Samsung Electronics TV model including an IPS liquid crystal panel and operated. The maximum light transmittance in a black state was calculated by the Extended Jones Matrix method using the TECHWIZ 1D (Sanai System, Korea) simulation program at the overall viewing angle. Here, reduction in light transmittance due to a color filter inside the panel was excluded from the above calculation. A lower maximum light transmittance indicates more effective suppression of light leakage and further improvement in visibility.

(2) Visibility with no voltage applied: The polarizing plate prepared in each of Examples and Comparatives Example was bonded to a 65-inch FFS panel (BOE, China) to evaluate visibility. Black visibility and colors were evaluated with the naked eye.

(3) Skin layer delamination: A portion of the polarizing plate between the negative B layer and the adhesive layer was separated by knife peeling and then analyzed by SEM. No skin layer delamination was evaluated as OK and skin layer delamination was evaluated as NG.

TABLE 1

| | | Example | | | | | Comparative Example | | |
|---|---|---|---|---|---|---|---|---|---|
| | | 1 | 2 | 3 | 4 | 5 | 1 | 2 | 3 |
| Negative | Thickness | 47 | 46 | 48 | 49 | 50 | 51 | 54 | 52 |
| B layer | of | | | | | | | | |
| | unstretched | | | | | | | | |
| | film (μm) | | | | | | | | |
| | TD | 1.3 | 1.35 | 1.28 | 1.25 | 1.40 | 1.17 | 1.1 | 1.13 |
| | stretching | | | | | | | | |
| | ratio | | | | | | | | |
| | (times) | | | | | | | | |
| | TD | 165 | 165 | 165 | 165 | 165 | 165 | 165 | 165 |
| | stretching | | | | | | | | |
| | temperature | | | | | | | | |
| | (° C.) | | | | | | | | |
| | Re (nm) | 100 | 100 | 100 | 100 | 100 | 100 | 116 | 116 |
| | Rth (nm) | 120 | 120 | 110 | 100 | 140 | 80 | 95 | 81 |
| | NZ | 1.7 | 1.8 | 1.6 | 1.5 | 1.9 | 1.3 | 1.3 | 1.2 |
| | Value of | 11.90 | 12.92 | 11.9 | 10.2 | 12.4 | 9.75 | 10.16 | 9.68 |
| | Eq. 1 | | | | | | | | |
| | Value of | 1.57 | 1.64 | 1.48 | 1.32 | 1.71 | 1.05 | 1.15 | 1.02 |
| | Eq. 2 | | | | | | | | |
| Positive | Rth (nm) | −130 | −135 | −125 | −120 | −100 | −110 | −100 | −112 |
| C layer | | | | | | | | | |
| Laminate | Re (nm) | 100 | 100 | 100 | 100 | 100 | 100 | 116 | 116 |
| of | Rth (nm) | −14 | −15 | −15 | −20 | −40 | 9 | −21 | −31 |
| negative | | | | | | | | | |
| B layer | | | | | | | | | |
| and | | | | | | | | | |
| positive | | | | | | | | | |

| | | | | | | | | |
|---|---|---|---|---|---|---|---|---|
| Angle (°) | 0° | 0° | 0° | 0° | 0° | 0° | 0° | 0° |
| Omnidirectional | 0.12 | 0.15 | 0.21 | 0.25 | 0.48 | 0.42 | 0.38 | 0.25 |
| maximum light | | | | | | | | |
| transmittance (%) | | | | | | | | |
| Visibility evaluation | Strong | Blue | Both | Both | Both | Weak | Both | Both |
| result with no voltage | blue | color | weak | weak | weak | yellow | weak | weak |
| applied | color | visible | yellow | yellow | yellow | color | yellow | yellow |
| | visible | | and | and blue | and | visible | and | and blue |
| | | | blue | colors | blue | | blue | colors |
| | | | colors | visible | colors | | colors | visible |
| | | | visible | | visible | | visible | |
| Skin delamination | OK | OK | OK | OK | OK | NG | NG | NG |

*Angle: Angle of slow axis of negative B layer with respect to light absorption axis of polarizer assuming that light absorption axis of polarizer is 0°.

As shown in Table 1, each of the polarizing plates of Examples had significantly low omnidirectional maximum light transmittance and thus was expected to provide sufficient improvement in suppression of light leakage. Each of the polarizing plates of Examples had excellent black visibility and thus was expected to secure improvement in lateral viewing angle and color visibility.

As shown in Table 1, the polarizing plates of Examples underwent no skin layer delamination from the negative B layer at an interface between the negative B layer and the bonding layer.

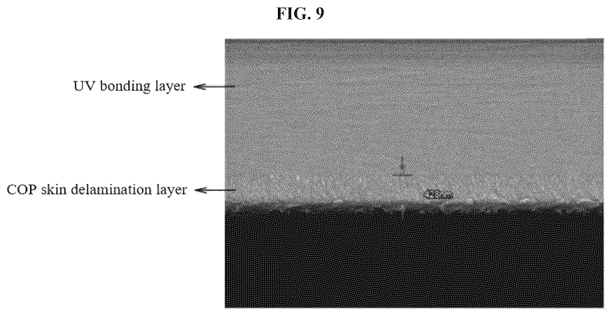

This result can be confirmed in FIG. 8. Referring to FIG. 8, it can be seen that the interface between the UV bonding layer and the negative B layer (COP film) is uniform, indicating that the negative B layer underwent no skin layer delamination.

As shown in Table 1, the polarizing plates of Comparative Examples underwent skin layer delamination from the negative B layer at an interface between the negative B layer and the bonding layer.

This result can be confirmed in FIG. 9. Referring to FIG. 9, it can be seen that the interface between the UV bonding layer and the negative B layer (COP film) is uneven and has irregular roughness, indicating that the negative B layer underwent skin layer delamination.

In the present disclosure, it will be understood that the term “comprise(s)/comprising,” “include(s)/including,” or “has (have)/having” specifies the presence of stated features, numbers, steps, operations, elements, and/or components, but do not preclude the presence or addition of one or more other features, numbers, steps, operations, elements, components, and/or groups thereof. Additionally, the terms “comprise(s)/comprising,” “include(s)/including,” “has (have)/having,” or other similar terms include or support the terms “consisting of” and “consisting essentially of,” indicating the presence of stated features, numbers, steps, operations, elements, and/or components, without or essentially without the presence of other features, numbers, steps, operations, elements, components, and/or groups thereof. Further, the use of “may” when describing embodiments of the present disclosure refers to “one or more embodiments of the present disclosure”.

In the present disclosure, expressions such as “at least one of,” “one of,” and “selected from,” when preceding a list of elements, modify the entire list of elements and do not modify the individual elements of the list. For example, “at least one of a, b or c”, “at least one selected from among a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±10% or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

In the context of the present disclosure and unless otherwise defined, the terms “use,” “using,” and “used” may be considered synonymous with the terms “utilize,” “utilizing,” and “utilized,” respectively.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims and equivalents thereof.

What is claimed is:

1. A polarizing plate comprising:
a polarizer; and
a retardation layer on a surface of the polarizer and comprising a positive C layer and a negative B layer,
wherein the negative B layer has a degree of biaxiality of 1.5 or more at a wavelength of 550 nm and a Raman spectrum value of 10.20 or more, as defined according to Equation 1:
$$Raman spectrum value = A / B , \qquad ( 1 )$$
where A is a value calculated by Equation 1-1:
$$A = \vert ( @ 921 {cm}^{- 1} / MD ) / \vert ( @ 1445 {cm}^{- 1} / MD ) , \qquad ( 1 - 1 )$$
in Equation 1-1, I(@921 cm⁻¹/MD) being intensity of a resulting Raman spectrum at a wavenumber of 921 cm⁻¹ in a machine direction (MD) of the negative B layer, and
I(@1445 cm⁻¹/MD) being intensity of a resulting Raman spectrum at a wavenumber of 1,445 cm⁻¹ in the MD of the negative B layer; and
where B is a value calculated by Equation 1-2:
$$B = \vert ( @ 921 {cm}^{- 1} / TD ) / \vert ( @ 1445 {cm}^{- 1} / TD ) , \qquad ( 1 - 2 )$$
in Equation 2-1, I(@921 cm⁻¹/TD) being intensity of a resulting Raman spectrum at a wavenumber of 921 cm⁻¹ in a transverse direction (TD) of the negative B layer, and
I(@1445 cm⁻¹/TD) being intensity of a resulting Raman spectrum at a wavenumber of 1,445 cm⁻¹ in the TD of the negative B layer.

2. A polarizing plate comprising:
a polarizer; and
a retardation layer on a surface of the polarizer and comprising a positive C layer and a negative B layer,
wherein the negative B layer has a degree of biaxiality of 1.5 or more at a wavelength of 550 nm and an FT-IR spectrum value of 1.20 or more, as defined according to Equation 2:
$$FT - IR spectrum value = C / D \qquad ( 2 )$$
where C is a value calculated by Equation 2-1:
$$C = \vert ( @ 2860 {cm}^{- 1} / MD ) / \vert ( @ 1445 {cm}^{- 1} / MD ) \qquad ( 2 - 1 )$$
in Equation 2-1, I(@2860 cm⁻¹/MD) being intensity of a resulting FT-IR spectrum at a wavenumber of 2,860 cm⁻¹ in a machine direction (MD) of the negative B layer, and
I(@1445 cm⁻¹/MD) being intensity of a resulting FT-IR spectrum at a wavenumber of 1,445 cm⁻¹ in the MD of the negative B layer; and
where D is a value calculated by Equation 2-2:
$$D = \vert ( @ 2860 {cm}^{- 1} / TD ) / \vert ( @ 1445 {cm}^{- 1} / TD ) \qquad ( 2 - 2 )$$
in Equation 2-2, I(@2860 cm⁻¹/TD) being intensity of a resulting FT-IR spectrum at a wavenumber of 2,860 cm⁻¹ in a transverse direction (TD) of the negative B layer, and
I(@1445 cm⁻¹/TD) being intensity of a resulting FT-IR spectrum at a wavenumber of 1,445 cm⁻¹ in the TD of the negative B layer.

3. The polarizing plate as claimed in claim 1, wherein the negative B layer is between the polarizer and the positive C layer.

4. The polarizing plate as claimed in claim 1, wherein the negative B layer comprises a resin having positive birefringence.

5. The polarizing plate as claimed in claim 1, wherein the negative B layer comprises a cyclic olefin polymer resin.

6. The polarizing plate as claimed in claim 1, wherein the negative B layer is a TD uniaxially stretched film.

7. The polarizing plate as claimed in claim 1, wherein the negative B layer has an in-plane retardation of about 70 nm to about 150 nm at a wavelength of 550 nm.

8. The polarizing plate as claimed in claim 1, wherein the negative B layer has an out-of-plane retardation of about 35 nm to about 195 nm at a wavelength of 550 nm.

9. The polarizing plate as claimed in claim 1, wherein the positive C layer has an out-of-plane retardation of about −150 nm to about −70 nm at a wavelength of 550 nm.

10. The polarizing plate as claimed in claim 1, wherein the positive C layer is a coating layer comprising at least one of a cellulosic compound or a polymer thereof, or an aromatic compound or a polymer thereof.

11. The polarizing plate as claimed in claim 1, wherein the retardation layer is on a light incidence surface or a light exit surface of the polarizer.

12. The polarizing plate as claimed in claim 1, wherein a thickness of a laminate of the positive C layer and the negative B layer is about 95% or more of a thickness of the retardation layer.

13. The polarizing plate as claimed in claim 1, further comprising: a protective layer on a surface of the polarizer.

14. The polarizing plate as claimed in claim 1, wherein the polarizing plate further comprises a first protective layer, the first protective layer being on a surface of the polarizer and between the polarizer and the positive C layer.

15. The first protective layer of claim 14, wherein the first protective layer has a front in-plane retardation and an out-of-plane retardation of each about 10 nm or less at a wavelength of 550 nm.

16. The polarizing plate as claimed in claim 2, wherein the negative B layer is between the polarizer and the positive C layer.

17. The polarizing plate as claimed in claim 2, wherein the negative B layer comprises a resin having positive birefringence.

18. The polarizing plate as claimed in claim 2, wherein the negative B layer comprises a cyclic olefin polymer resin.

19. An optical display apparatus comprising the polarizing plate as claimed in claim 1.

20. An optical display apparatus comprising the polarizing plate as claimed in claim 2.
